(19) United States
(12) Patent Application Publication
(10) Pub. No.: US 2006/0224449 A1
(43) Pub. Date: Oct. 5, 2006

(54) Integrating transaction features into a POS system

(75) Inventors: Douglas Byerley, Overland Park, KS (US); Timothy Maurer, Bellevue, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 11/100,327

(22) Filed: Apr. 5, 2005

(51) Int. Cl. G06Q 30/00

(52) U.S. Cl. 705/14

(57) ABSTRACT

A system to process transactions that includes a transaction terminal, and a transaction network selection device in communication with the transaction terminal and also in communication with a plurality of financial data networks, where the transaction network selection device selects one of the financial data networks to conduct the transaction, based on tender information supplied to the device. Also, a method of processing a transaction that includes providing a transaction terminal, and a transaction network selection device that is in communication with the transaction terminal and also in communication with a plurality of financial data networks, and selecting, with the transaction network selection device, one of the financial data networks to conduct the transaction based on tender information supplied to the device.

### BACKGROUND OF THE INVENTION

A modern point-of-sale (POS) station in a retail store has become a complex collection of legacy devices and systems. The conventional cash register has been augmented by a computer system programmed to receive and process data collected in a modern point-of-sale transaction. For example, the computer system is adapted to receive data from a bar code reader, radio frequency identification (RFID) chip reader, etc., about an item being purchased, as well as other data from a payment instrument reader (e.g., credit/debit card reader) and loyalty card information. The computer system also has to communicate with many different external transaction systems (e.g., credit card processing systems, debit card processing systems, check processing systems, etc.).

The increasing popularity of rewards programs are putting pressure on merchants to upgrade their POS systems, to receive and process rewards data. Some rewards programs include “instant rewards” that allow a customer to apply at least a portion of their reward points towards an item being purchased. A merchant wishing to participate fully in these instant rewards programs should have a point-of-sale station capable of collecting reward information from both the customer, and the items being purchased, communicating with a rewards program host network, allowing the customer to input a reward choice, and displaying and printing rewards contributions to the transaction.

Unfortunately, incorporating all the additional rewards program functionality into existing POS systems is difficult and expensive. In many systems, hardware as well as software has to be replaced for the system to be fully operational for processing instant rewards. For merchants with large numbers of point-of-sale stations, regularly upgrading or replacing the stations can be prohibitively expensive. Thus, there is a need for methods and systems that can give a POS station the capability to process rewards, without having to perform extensive software and hardware upgrades on the current equipment.

Merchants who want their POS systems to be capable of participating in many different rewards programs have to make sure those systems are capable of processing transactions on different transaction processing networks. Oftentimes, different transaction processing networks use different hardware standards, communication protocols, data formats, transaction processing algorithms, etc., and a POS system has to be capable of conducting transactions across these different networks. Thus, there is also a need for methods and systems that can conduct transactions across additional transaction networks without having to perform extensive software and hardware upgrades on the current equipment. These and other problems are addressed by the invention described below.

### BRIEF SUMMARY OF THE INVENTION

Embodiments of the present invention relate to systems and methods for conducting a transaction involving a rewards program. One such system may include a transaction terminal, and a rewards program processing device in communication with the transaction terminal. The rewards program processing device selects a financial data network for conducting the transaction based on rewards program information supplied to the device.

Embodiments of the invention also relate to systems to process transactions. The system may include a transaction terminal, and a transaction network selection device in communication with the transaction terminal and also in communication with a plurality of financial data networks. The transaction network selection device selects one of the financial data networks to conduct the transaction, based on tender information supplied to the device.

Embodiments of the invention may also relate to methods of processing a transaction. The methods may include providing a transaction terminal, and a transaction network selection device that is in communication with the transaction terminal and also in communication with a plurality of financial data networks. The methods may include selecting, with the transaction network selection device, one of the financial data networks to conduct the transaction based on tender information supplied to the device.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

FIGS. 1A-C show systems for conducting financial transactions according to embodiments of the present invention;

FIG. 2 is a flowchart illustrating methods of processing a reward during a transaction according to embodiments of the invention; and

FIG. 3 is a flowchart illustrating methods of processing transactions across multiple transaction networks according to embodiments of the invention.

### DETAILED DESCRIPTION OF THE INVENTION

The present invention includes systems and methods to conduct transactions involving rewards programs. These systems may combine a legacy or traditional POS transaction system with a device that allows the legacy system to participate in a variety of rewards programs. The device may allow the legacy system to communicate with multiple transaction processing networks that the system otherwise could not access without significant software and/or hardware changes. The device may also be used to transmit communications for more than just rewards programs, including enabling the legacy system to conduct and settle transactions between a customer and merchant over multiple transaction networks.

The device may be an external piece of equipment (e.g., a box, wedge, etc.) positioned above, below, or adjacent to the legacy system. The device may include connectors for wires and cables to couple the device to both legacy systems and the transaction networks. The device may include one or more serial ports, parallel ports, IP ports, or the like. The device may be designed such that almost no changes need to be made to the legacy system to make it compatible with the transaction networks. For example, the device simply needs to be plugged into an existing connector on the legacy system to enable operations. In another embodiment, the device communicates wirelessly with the legacy system, the networks, or the like. This may occur, for example, using a wireless port or device contained in or coupled to the device and/or to the legacy system.

In additional embodiments, the device may be a chip or peripheral card that is incorporated into the legacy system. For example, the device may be a peripheral card adapted to be inserted into an existing slot in a legacy device. Likewise, the device may be a chip adapted for insertion into a socket on a chip board in the legacy system. In another embodiment, the chip or peripheral card is incorporated into a printer system, which also may comprise part of the legacy system.

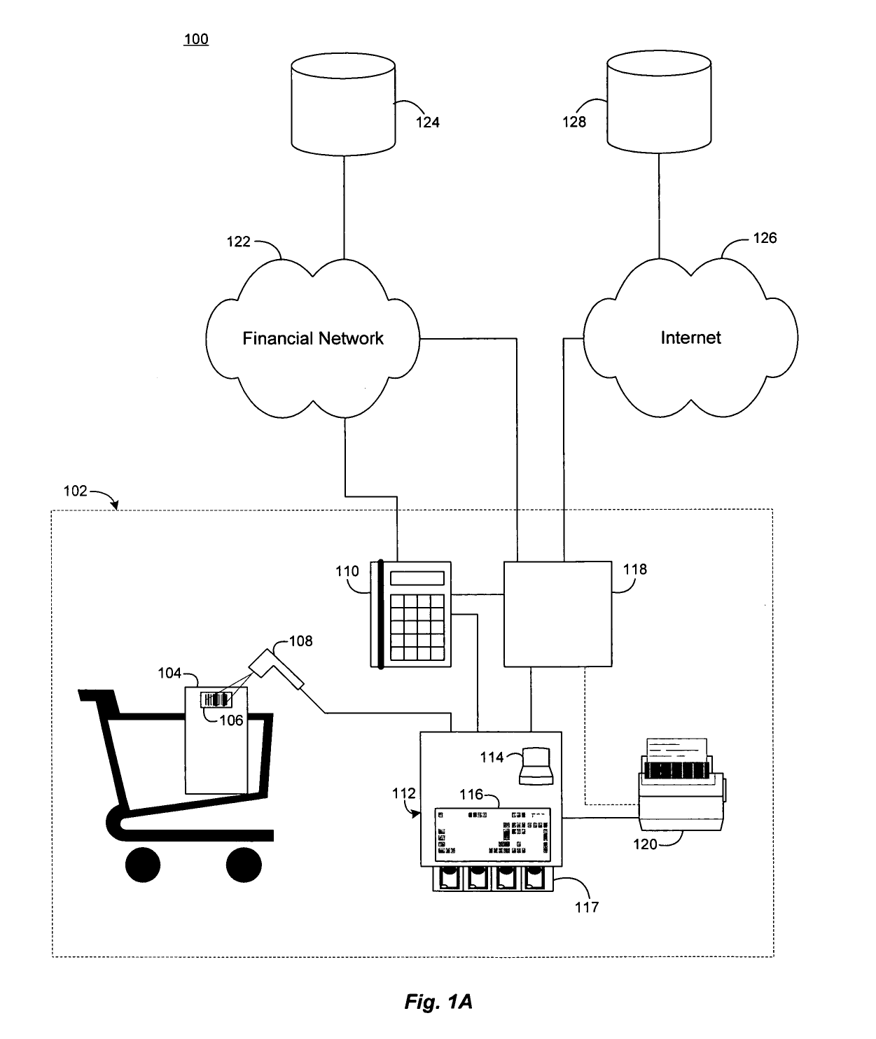

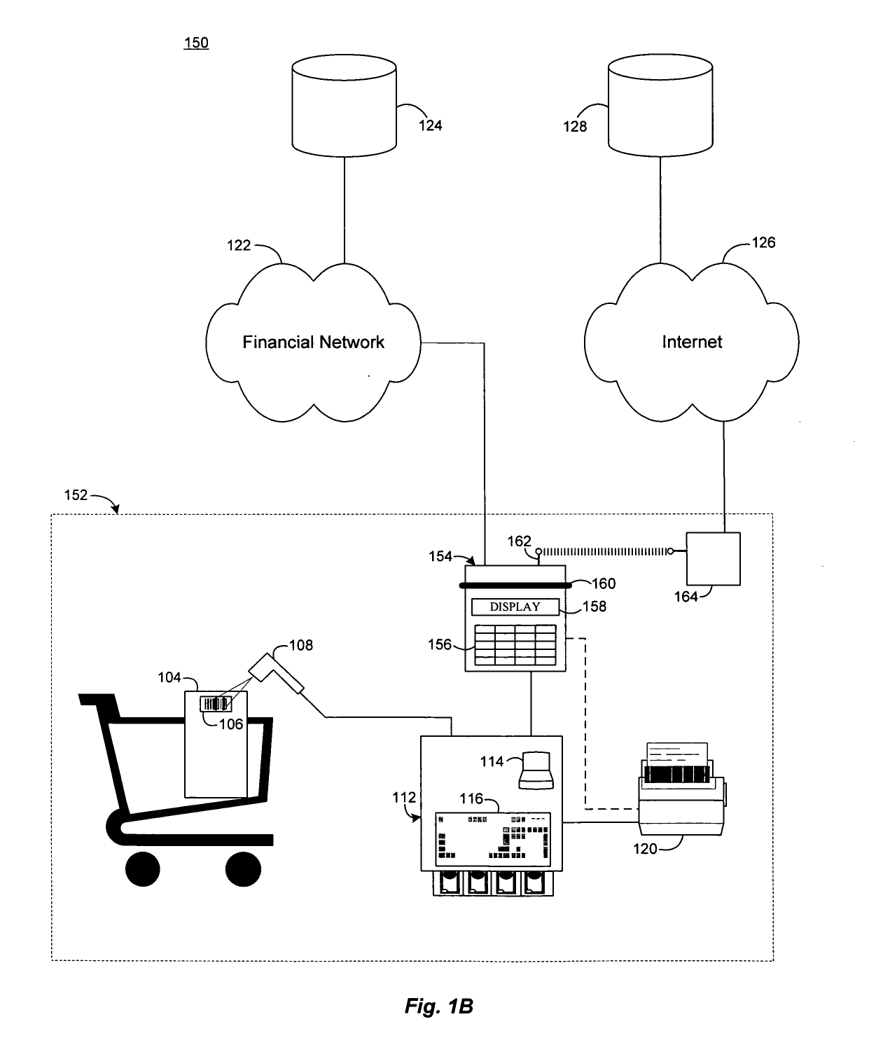

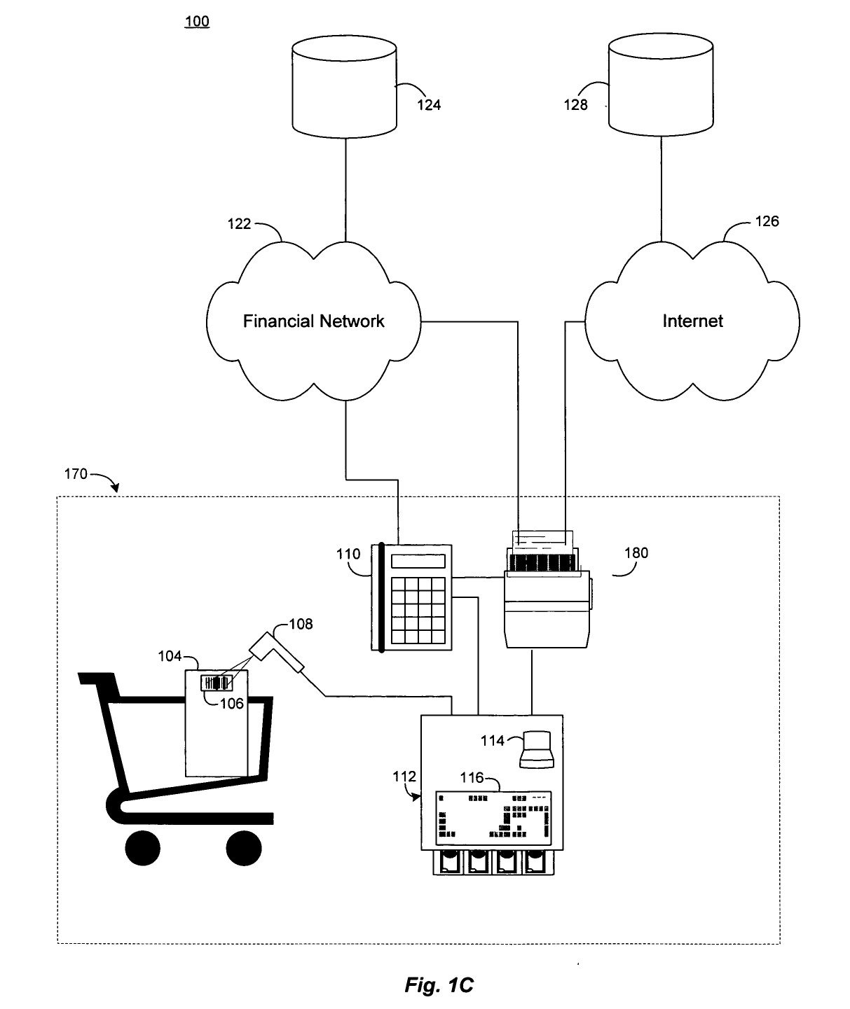

Referring now to FIG. 1A, a simplified schematic depicts an embodiment of a transaction processing system 102 coupled to a private financial network 122, and another transaction processing network that is accessible through the Internet 126. In one embodiment, system 102 includes a transaction terminal 112 having a display 114 and a key entry input 116. Terminal 112 may also be adapted to hold currency, checks, etc. in a drawer 117.

Transaction terminal 112 may include a microprocessor or logic to process, display and print information about the transaction. The information may come from multiple sources, including key entry input 116 on terminal 112. For example, product information, such as a SKU#, serial number, inventory number, etc., may be typed into the transaction terminal 112 through input 116.

Information may also be generated by a product data input terminal, such as a scanner 108, which reads product information encapsulated in a bar code label 106 attached to a product 104. Product data input terminals may also include radio frequency identification (RFID) chip readers, and other product label scanning devices (not shown). In still other embodiments, a biometrics reader is included, coupled to transaction terminal 112 and/or to device 118 for receipt of a customer biometric (finger print, voice print, iris scan, or the like). This may be useful, for example, to verify the customer's age against a database record when the customer is purchasing age-restricted items (e.g., alcohol, tobacco products, firearms, etc.).

Information may further be generated by a payment input terminal 110 capable of reading tender information from a customer's magnetic stripe payment card, and may also read loyalty program information and/or rewards program information from the same card, or a different card, provided by the customer. Payment input terminal 110 may also receive information from contactless payment instruments presented by the customer (e.g., RFID chips). The information received from the customer RFID card may include loyalty and/or payment information. Additional details on contactless transaction instruments can be found in U.S. patent application Ser. No. 11/005,864, filed Dec. 6, 2004, by Brian Kean et. al., entitled Punchout Contactless Transaction Card, the complete disclosure of which is incorporated herein by reference for all purposes.

Additional information about the transaction may be generated by a device 118, which facilitates communication between system 102, and one or more transaction networks. Device 118 may receive rewards data, transaction data, etc., from a database 124 through a network 122, and/or from a database 128 through a network 126, and then forward the data to transaction terminal 112. If necessary, device 118 translates the data received from networks 122 and 126 into a format compatible with the other components of system 102 (e.g., transaction terminal 112, payment input terminal 110, etc.). Device 118 may also facilitate the communication of a transaction authorization between networks 122 and 126, and components of system 102. To do so, device 118 may have a processor and/or logic to calculate an adjusted transaction price based on the information received from networks 122 and 126. In some embodiments, device 118 includes a processor, which may be a micro processor or the like, coupled to a memory. The memory maintains appropriate software for the operation of device 118, including the operation of device 118 during one or more financial transactions. For example, the software or logic in device 118 may operate to select the appropriate network 122, 126 with which to communicate.

In one particular embodiment, device 118 receives rewards account information from payment input terminal 110 and/or transaction terminal 112. The rewards account information may include, for example, a rewards account identifier or number associated with the particular customer's rewards account. Device 118, in some embodiments, communicates with a database containing SKU-based purchase history and rewards account information for that customer's account. By way of example, database 128 may be a database containing rewards account information for a plurality of customers. Device 118 interfaces with database 128, or a server or processor coupled thereto, by way of the internet 126 to receive appropriate information on the customer's rewards account. Once the transaction is ready to be finalized, device 118 may communicate with database 124, or a server or processor coupled thereto, in order to transmit payment information, transaction information, or the like. In this manner, device 118 selects the appropriate financial data network or other network with which to communicate. This selection may be based, at least in part, on tender information such as rewards account information received from the customer. It will be appreciated by those skilled in the art that the above described example is but one of many methods of operation of device 118 to facilitate transactions involving rewards accounts, within the scope of the present invention.

When a transaction is authorized to proceed, transaction terminal 112 may use the information generated about the transaction to calculate a final transaction amount. For example, terminal 112 may use product information input by a cashier through key entry input 116, or scanner 108, to search for product-specific discounts, sales, instant rebates, etc., being offered by the merchant, manufacturer, or some other incentive provider. Terminal 112 may then calculate an adjusted transaction amount based on the product information.

Transaction terminal 112 may also use reward information from device 118 to calculate the final transaction amount. The reward information may include a discount, credit, etc., that a reward program member is able to apply towards the transaction amount of the product or service being purchased. For example, a member who has accrued reward points through a reward program may be eligible to apply at least a portion of those points towards reducing the transaction amount at the point of sale. In one embodiment, transaction terminal 112 calculates a reduced transaction amount based on the number of reward points used in the transaction. The final transaction amount may be calculated based on adjustments from both rewards information and product information, as well as incentives, such as merchant or manufacturer coupons provided by the purchaser.

The final transaction price may be shown on display 114, and/or a display on payment input terminal 110, and may also be printed on a receipt by a receipt generator 120. The displays may show a pre-adjusted transaction amount before adjustment by the rewards information, and the rewards-adjusted transaction amount. In one embodiment, the rewards program member has the option of purchasing the product or service at the pre-adjusted transaction amount, keeping the rewards points, or using the points to complete the transaction at the rewards-adjusted transaction price. In this manner, the customer can determine whether they want to redeem reward points for this transaction. The rewards program member may also be able to select the number of rewards points to apply towards the transaction amount by, for example, inputting the number of rewards points at payment input terminal 110. The final transaction amount may then be calculated and/or presented at terminal 110 and/or transaction terminal 112 based on the selected number of reward points.

The purchaser may receive a written receipt of the transaction at the point of sale from receipt generator 120. The written receipt may include the time and date of the transaction, a description of the product or service purchased, and the final transaction amount. The receipt may also include an amount saved that represents the difference between the final transaction amount and the initial price of the product or service. In addition, the receipt may include a quantity of rewards points used and/or earned by the transaction. Additionally, in one embodiment device 118 drives a message to receipt generator 120 so that a bar code is printed onto a receipt. The bar code includes a reward redemption amount. The receipt bar code could be presented for redemption at POS scanner 108, via a kiosk, at another location, at another vendor, or the like. Device 118, in one embodiment, drives a message for a map to receipt generator 120 to be printed onto the receipt. In one embodiment, the map denotes a separate location where the recipient can redeem the reward or redemption. Device 118 also may drive a message to receipt generator 120 to produce artwork or a photograph depicting additional merchandise that could be redeemed or purchased, or the like.

As noted above, device 118 may assist in the processing of transaction across multiple transaction networks, even when a rewards program is not involved. In the embodiment shown, device 118 communicates with a first transaction processing network 122 through a private, dedicated wide-area network, and communicates with a second transaction processing network 126, through the public Internet. The connection between device 118 and first transaction processing network 122 may be established with a private network connection over a standard telephone line, or a dedicated connection, such as a T1 line. The connection between device 118 and second transaction processing network 126 may be established through an Internet connection, such as a dialup telephone connection, cable modem connection, DSL connection, T1 line, etc. Device 118 may also communicate with additional transaction processing networks (not shown).

Using a connection via the Internet or via a dedicated line, device 118 acts as a two-way communication device between the legacy POS system and one or more financial transaction networks. Device 118 operates to route data directly to the financial transaction network independently of any existing merchant payment terminal based, at least in some embodiments, on discerning account information and bank information provided via the magstripe card or payment instrument. In some embodiments, logic in device 118 enables the routing.

Networks 122 and 126 may include one or more servers (not shown) that receive and process commands from device 118. The servers may be coupled to databases 124 and 128 storing information about a transaction account and/or a rewards program account identified by tender information forwarded by device 118. The information stored in the databases may include a transaction history of the rewards account, rewards eligibility criteria for transactions conducted with the account, balances and credit limits for the account, reward points accrued in the account, etc.

The information about a transaction sent by networks 122 and 126 may be used by device 118 to calculate an adjusted transaction amount for the product or service purchased. Alternatively, the information may be translated, if necessary, and forwarded to other components of system 102 to calculate the transaction amount. In the embodiment shown in FIG. 1A, device 118 may send the information through connections to transaction terminal 112, payment input terminal 110, and optionally to receipt generator 120.

Embodiments include conducting all communications between POS system 102 and transaction processing networks 122 and 126, through device 118. Alternatively, a portion of the transactions may bypass device 118 and be conducted, for example, between the network and payment input terminal 110, and/or transaction terminal 112. For example, in one embodiment, a credit card payment authorization may occur between input terminal 110 and financial network 122, bypassing device 118.

In some embodiments, device 118 includes memory for storing transaction information. Information about individual transactions may be retrievable from the memory based on the time and date the transaction originated, as well as the transaction processing network through which the transaction is processed. Some embodiments of the invention provide for the delayed completion and/or settlement of multiple transactions (e.g., the close of business for the day, end of weekly settlement cycle, end of monthly settlement cycle, etc.). Information about each transaction may be stored in the memory of device 118 until processing time, when multiple transactions may be finalized in a batch process across a designated transaction processing network. The batch process may be repeated for transactions using the different transaction processing networks. Embodiments also provide for completing some transactions without delay (e.g., transactions that bypass device 118), while storing other transactions in the memory of device 118 for completion at a later time. In other embodiments, device 118 does not have a substantial memory capability for data storage. In some of these embodiments, the legacy system maintains the necessary data storage at the merchant location, at an off-site location, or the like.

Referring now to FIG. 1B, an embodiment of another POS system 152, which includes a device 154, is shown. Device 154 may include at least some of the functionality of both payment input terminal 110, and device 118 described above. For example, device 154 may include a magnetic strip reader 160 to read information from transaction cards, loyalty cards, rewards cards, etc. Device 154 may also include a keypad 156 and a display 158 to allow a cardholder to enter and view information about the transaction.

Device 154 may communicate with transaction processing networks via wireless and wireline connections. In the embodiment shown, device 154 communicates wirelessly with a transceiver 164 via a node 162. Transceiver 164 may communicate with multiple nodes 162 in multiple POS systems 152 positioned throughout a merchant's store, business, etc. Transceiver 164 may then relay messages from node 162 to the Internet and transaction processing network 126.

FIG. 1C depicts an alternative embodiment of a point of sale system 170 according to the present invention. System 170 includes many of the same components and features as described in conjunction with the systems in FIGS. 1A and 1B. For example, system 170 includes payment input terminal 110 and transaction terminal 112 substantially as described. In this embodiment, however, the functionality of device 118 is contained within a receipt generator, device or printer 180. For example, receipt generator 180 may include a processor for performing the functions of device 118 using logic and/or software maintained within receipt generator 180. These functions include, without limitation, receiving and transmitting financial transaction data to one or more financial networks, including, to network 122 and/or network 126. In one embodiment, printer 180 includes a processor coupled to a memory for maintaining the software or instructions for printer 180 operation. In other embodiments, printer 180 does not have a substantial memory capability for data storage. In some of these embodiments, the legacy system maintains the necessary data storage at the merchant location, at an off-site location, or the like. In a particular embodiment, printer 180 includes a serial port and an IP port. The serial port may be used, for example, for coupling to input terminal 110, to a keypad, to a check reader, or the like. The IP port may be coupled to networks 122, 126 or the like. Printer 180 may have more than one of a same type of port in other embodiments.

Receipt generator 180 also may receive and/or transmit rewards account information to/from networks 122, 126, as well as to/from payment input terminal 110 and/or transaction terminal 112. As the name implies, receipt generator 180 is further equipped to print transaction receipts for a customer. The receipts printed by receipt generator 180 may include information on products 104 purchased by the customer, as well as details on the redemption or acquisition of reward points associated with the purchase of one or more items 104.

In one embodiment, device 180 receives account numbers read from a customer-provided card by a magnetic stripe reader, bar code reader, RFID reader or image capture device. Device 180 then discerns the specific type of reward or payment card or instrument, such as by using logic stored within the card and/or device 180. Device 180 also may obtain information to discern the card type through a connection to a host to access an eligibility or payment routing table. Using logic on device 180 or messaging sent to device 180 via the host, device 180 can parse and route the payment or the non-payment transaction to the appropriate network.

Device 180 captures the specific account or bank identification numbers (BINs), or lack thereof, by reading the magnetic stripe, by image capture, by an RFID reader, or the like. Device 180 can discern the type of card and whether the card is a reward card (e.g., a non-payment instrument card), a reward card with a “payment purse” registered to it but where the reward card is not a payment card, a private label credit or debit card without any association with a proprietary payment network, a payment card (e.g., a debit or credit card) associated with a proprietary payment network, or the like. Based at least in part on the card type, device 180 will route the transaction to a network dedicated to processing that type of card. Four scenarios are provided as a non-limiting example.

First, a store rewards card (non-payment card) can be presented at the POS legacy system 112, such as when a customer or store clerk swipes the card through a card reader (input device 110), or scanner 108. In this example, the card has an account number that does not have any payment affiliation or instrument associated with it. In this embodiment, device 180 identifies the card as such and routes the card information to an appropriate rewards-only processing network (e.g., network 126). In some embodiments, reward account information is accessed from database 128 by a server coupled thereto, and appropriate reward account information for the customer associated with the rewards card is returned to device 180. For example, network 126 may return information that the customer is indeed a rewards customer, and that they have attained a certain reward status, are within a certain dollar amount from a reward status, or a wide range of other reward-related information. Information returned to device 180 from the rewards network may further include verification that the customer is a rewards customer, and may include reward or loyalty information for the customer's account. In some embodiments, the rewards information received from the rewards network is made available to the customer during the current transaction. This may occur, for example, by device 180 printing the information on a piece of paper, on a receipt, or the like. Alternatively device 180 may return the rewards information to terminal 112 for presentation to the customer. In still other embodiments, the customer-related rewards information is provided to the merchant, but may or may not be involved with immediate redemption. For example, in one embodiment, the customer-related rewards information returned to device 180 is used to trigger the printing of a coupon for the customer to use the next time they visit the merchant. The coupon may encourage customer activity that is desired by the merchant, for example, the use of a particular credit instrument or credit card, a reduction in price of a particular item, or the like.

In another embodiment, the reward card is not a payment card, but has payment instrument(s) or “purse(s)” registered to it such that the payment can be deducted via an ACH from a cardholder's account(s). The reward card in this example is neither a debit card nor a credit card, and reward account information read from the card is routed directly through the reward network as described above. In one embodiment, device 180 sends a message for an ACH payment to be deducted from a registered “purse” account to pay for some or all of the transaction. In one embodiment, the operation of device 180 does not necessarily require the payment to be processed via the existing merchant payment terminal 112, nor through the merchant processing relationship, nor via the existing proprietary payment network. In this manner, device 180 operates to bypass the merchant payment terminal and the proprietary payment processing network.

In another example, the card presented to scanner 108 or input terminal 110 is a store card associated with a private label account that is not associated with any proprietary payment system, but that has a credit or debit account associated therewith. The card is presented to scanner 108 or input terminal 110, and the Account Number and Bank Identification Number (BIN) indicate it is a card that is not associated with a proprietary payment system. In this manner, the account and/or transaction information is routed through a closed-loop payment network for authorization and settlement. In a particular embodiment, this operation does not necessarily require the payment to be processed via the existing merchant payment terminal, nor by the merchant processing relationship, nor via the existing proprietary payment network. In this manner, device 180 operates to bypass the merchant payment terminal and the proprietary payment processing network.

Finally, a card presented to scanner 108 or input terminal 110 may be associated with a particular proprietary payment system (e.g., Star, Amex, Visa, MC, Discover). The Account Number and Bank Identification Number indicate that the card is associated with the proprietary payment system, so device 180 routes the transaction information either through a closed loop network or via the respective proprietary system network requirements. In a particular embodiment, this operation does not necessarily require the payment to be processed via the existing merchant payment terminal, nor by the merchant processing relationship, nor via the existing proprietary payment network. In this manner, device 180 operates to bypass the merchant payment terminal and the proprietary payment processing network.

In some embodiments, device 180 is further adapted to print gift cards in addition to printing transaction receipts. For example, in one embodiment the customer desires to purchase a fifty dollar ($50.00) gift card. The card may comprise a plastic card, a paper stock, or the like. The customer or store clerk inserts a card into device 180, and device 180 prints gift card information on the card. The printed information may include, for example, merchant information (store name, store hours, logos, etc.), the gift card's initial value (e.g., $50.00), a gift card identifier (e.g., an alphanumeric string of characters unique for the gift card), and/or a bar code containing some or all of the other printed information. Alternatively, some or all of the gift card information is already printed on the card, with device 180 operating to print a remaining portion of the information (e.g., a bar code corresponding to the purchased denomination). In this manner, the merchant need not stock large numbers of gift cards, but instead can personalize the cards at the point-of-sale for particular denominations.

In another embodiment of the present invention, device 180 will be useful for transmitting information on purchased items 104 or services to a network for additional processing. By way of example, device 180 receives information from bar code 106 or some other product identifier, via scanner 108, input device 110 and/or transaction terminal 112. In this example, device 180 identifies the purchased item as a prescription drug, a doctor's office charge, or the like. Device 180 then sends information on this purchased item or service to a health care provider network. Device 180 also sends to the network information obtained from a customer medical card scanned or otherwise read by scanner 108, input terminal 110, or the like. The health care provider network uses information from the customer medical card to verify the customer has a medical account, and returns appropriate information to the merchant. The medical account may be, for example, a medical coverage account provided to the customer and/or the customer's family, such as by the customer's employer. The information returned to the merchant by the health care provider network may include, for example, the customer co-pay required to be collected by the merchant, the customer deductible, or the like. In this manner, device 180 facilitates near real time communications between the health care provider network and the customer, by way of the merchant point-of-sale.

In another embodiment, the medical account is a medical reimbursement account containing pre-tax dollars deposited by the customer. Device 180 sends information about the customer (e.g., the customer's account number read from a medical account card), and about the item being purchased (e.g., a prescription or non-prescription drug, a medical office charge, or the like) to a medical reimbursement processing network. For items that are legitimate purchases from such a medical account, the network can process a reimbursement request along with the customer's purchase of the item. In this manner, the customer is reimbursed from their medical reimbursement account much quicker than if the customer had to submit a receipt for the purchase to the claims processing department of the medical reimbursement account network.

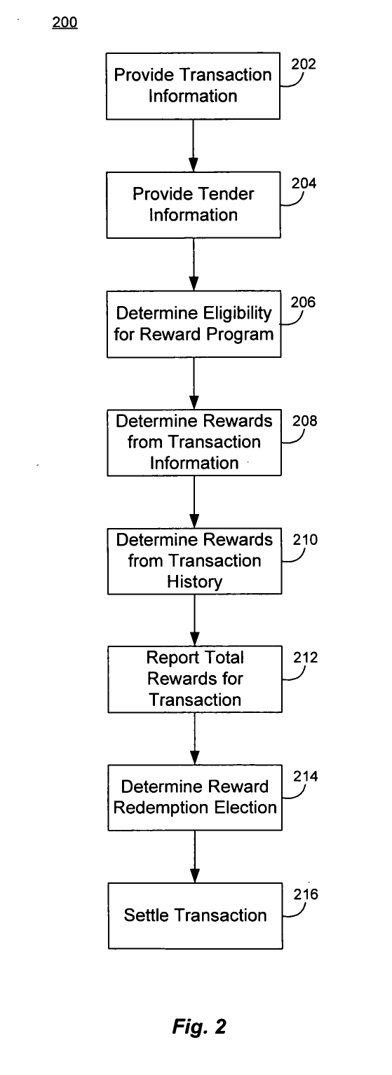

Turning now to FIG. 2, a flowchart illustrating a method of processing a reward during a transaction according to embodiments of the invention is shown. The method includes providing transaction information (Block 202). The transaction information may include the date, time and place of the transaction, the identity of the purchaser, product information, store information, loyalty information, and rewards program information, among other kinds of information. In some embodiments, SKU-based information is received from the product and recorded and/or sent to a rewards account network. This information may be obtained from a product label, loyalty card, and/or rewards program card, among other sources. In some embodiments, a reward program account identifier is obtained from the customer, such as by reading a magstripe on a rewards account card. Specifics of the reward customer's account (e.g., number of reward points available for purchases, discounts, etc.), may be received from a rewards account database or rewards account network.

In addition, tender information is provided (Block 204), such as by a payment instrument provided by the purchaser. The tender information may include transaction account identification information, bank identification numbers (BIN), transaction processing network information, and personal identification number information, among other types of information. The payment instrument may include a credit card, debit card, check card, stored-value card, loyalty card, rewards card, and/or gift card, among other types of cards. The tender information may be obtained from the payment instrument by a contact transaction instrument reader (e.g., magnetic stripe reader), or contactless transaction instrument reader (e.g., RFID chip, bar code reader, etc.). In one embodiment, the payment instrument comprises reward account information, such as a reward account identifier.

Method 200 includes determining whether the transaction is eligible to be included in the rewards program (Block 206). The eligibility determination may be made based on transaction information, tender information, loyalty program information, and/or rewards program information, among other types of information. For example, the rewards program information may include data to identify a rewards account associated with the customer. The identification data may be used by a rewards host in communication with the transaction processing network to confirm customer eligibility to receive rewards. In some embodiments a confirmation is sent, via a transaction processing network, back to the POS system where the reward may be determined. Alternatively, the confirmation permits the rewards host to determine the reward.

In some embodiments, method 200 includes capturing SKUs for purchased items, and sending the SKUs to a rewards network. In those embodiments, method 200 would further include determining the SKUs eligibility in the rewards program, and transmitting the SKU to a database. In this manner, method 200 would identify the products and/or services eligible for earning points towards various rewards in the reward programs run by the rewards network and/or the merchant.

The reward is determined based on transaction information (Block 208), which may include data on the transaction price, the identity of the product or service, and/or the location, date, and time of the transaction, among other data. For example, a reward may be calculated as a cash back percentage of a portion of the transaction price. In another example, the reward may be calculated as a number of reward points based on the transaction price (e.g., points/unit currency×transaction price).

Rewards may also be determined or modified based on the transaction history of the rewards program account (Block 210). As noted above, a rewards program host may receive data to identify the rewards account associated with the customer. The rewards account may include a transaction history listing data about transactions conducted through, or in some way affiliated with, the rewards program. This transaction history may be used to modify the reward determined in Block 208. In some embodiments of method 200, the total rewards for the transaction are reported (Block 212). The total rewards may be reported to the customer, such as through the printing of a receipt, the display of rewards on a terminal or payment input device, or the like. Reporting the total rewards for the transaction may include reporting the available customer rewards to the customer so that the customer may determine the amount, if any, of reward points to be redeemed for a particular transaction. The reporting of total rewards also may comprise reporting the rewards back to a rewards account database, such as database 124 or 128. Method 200 may further include determining the reward redemption election (Block 214). This process may include, for example, presenting the customer with the option of redeeming certain reward points during a particular transaction. Determining the reward redemption election may include recognizing the customer request for the redemption of some or all of the reward points for a particular transaction. Finally, method 200 may include settling the transaction (Block 216). Settling the transaction may include the transmission of money collected by systems 102, 152, and/or 170. Settling the transaction may further include receiving tender from the customer for the particular transaction.

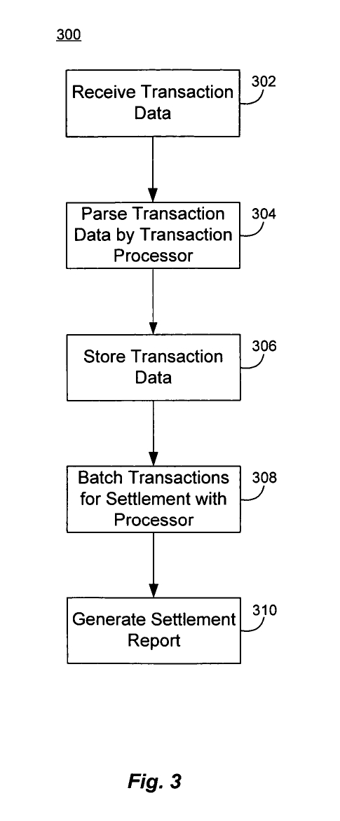

FIG. 3 depicts an alternative embodiment of a method according to the present invention. Method 300 includes receiving transaction data (Block 302) and parsing transaction data by a transaction processor (Block 304). In a preferred embodiment, the receipt and parsing of transaction data occurs for multiple transactions, and is performed by a POS system 102, 152, 170. In some embodiments, devices 118 or 154 or 180 receive and parse the transaction data. Method 300 includes storing the transaction data (Block 306). In one embodiment, this data is stored within device 118, 154, and/or 180, such as within memory. Method 300 then includes batching transactions for settlement with a processor (Block 308) and generating a settlement report (Block 310). Batching transactions may include, for example, organizing transactions associated with various financial networks so that a group of transactions may be settled simultaneously. The parsing of transactions in Block 304 may be geared toward parsing transactions so that they align with the appropriate financial networks, reward programs, product manufacturers, or the like, to facilitate batch settlement. The settlement reports may be used to maintain accurate reporting of transactions and exchange of monies for the various transactions.

Having described several embodiments, it will be recognized by those of skill in the art that various modifications, alternative constructions, and equivalents may be used without departing from the spirit of the invention. For example, while many of the above described embodiments involve rewards or loyalty programs, the invention is not so limited. Devices 118, 180 may receive a wide range of information from the legacy POS system, including without limitation, information from demand deposit account (DDA) payment cards, electronic check acceptance devices, and the like. Device 118 and/or 180 may send some or all of the intercepted information to one or more appropriate networks, and receive information in return. The information received from the network(s) may include, without limitation, an approval, a verification, a message, or the like, depending in part on the information sent and the network with which device 118, 180 is communicating. Additionally, a number of well known processes and elements have not been described in order to avoid unnecessarily obscuring the present invention. Accordingly, the above description should not be taken as limiting the scope of the invention.

As used herein and in the appended claims, the singular forms “a”, “and”, and “the” include plural referents unless the context clearly dictates otherwise. Thus, for example, reference to “a process” includes a plurality of such processes and reference to “the network” includes reference to one or more networks and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, or groups.

The invention has now been described in detail. However, it will be appreciated that the invention may be carried out in ways other than those illustrated in the aforesaid discussion, and that certain changes and modifications may be practiced within the scope of the appended claims. Accordingly, the scope of this invention is not intended to be limited by those specific examples, but rather is to be accorded the scope represented in the following claims.

What is claimed is:

1. A system for conducting a transaction involving a rewards program, the system comprising:
a transaction terminal; and
a rewards program processing device in communication with the transaction terminal, wherein the device is adapted to select a transaction data network for conducting the transaction based at least in part on rewards program information supplied to the device.

2. The system of claim 1, further comprising a payment input terminal adapted to receive the rewards program information and coupled to the transaction terminal.

3. The system of claim 1, further comprising a product data input device adapted to receive product information and coupled to the transaction terminal.

4. The system of claim 3, wherein the transaction terminal is adapted to search for a product discount associated with the product information, and calculate an adjusted transaction amount based on the discount.

5. The system of claim 4, wherein the rewards program processing device is adapted to receive rewards data from the selected transaction data network.

6. The system of claim 5, wherein the transaction terminal is adapted to calculate a final transaction amount based on the adjusted transaction amount and the rewards data.

7. The system of claim 6, further comprising a display device coupled to the transaction terminal, the display device adapted to display the final transaction amount, and a savings amount comprising the difference between the final transaction amount and an initial product price.

8. The system of claim 1 wherein the rewards program processing device further comprises a printer.

9. A system to process transactions comprising:
a transaction terminal; and
a transaction network selection device in communication with the transaction terminal and also in communication with a plurality of financial data networks, wherein the transaction network selection device selects one of the financial data networks to conduct the transaction, based on tender information supplied to the device.

10. The system of claim 9, wherein the transaction network selection device is adapted to use reward program information to select the one financial data network to conduct the transaction.

11. The system of claim 9, wherein the transaction network selection device is adapted to translate data from the transaction terminal into a form that is understandable by the selected financial data network.

12. The system of claim 9, wherein the transaction network selection device is adapted to store data on multiple transactions in a memory before conducting the transaction on the selected financial network.

13. The system of claim 12, wherein the multiple transactions are parsed into groups based on the financial network selected to conduct the transaction.

14. The system of claim 13, wherein the groups of transactions are settled on the selected financial network in a batch process.

15. The system of claim 9, wherein the transaction is settled using the selected financial network before the system starts processing another transaction.

16. The system of claim 9, wherein the plurality of financial data networks comprises a first financial data network that uses the Internet, and a second financial data network that uses a private financial data network.

17. The system of claim 9, wherein the transaction network selection device is adapted to read tender information from a transaction card possessed by a customer participating in the transaction.

18. The system of claim 17, wherein the transaction card is selected from a group of cards consisting of a gift card, a stored-value card, a loyalty card, a credit card, a debit card, a check card, a health care spending account card, and a merchant-sponsored card.

19. The system of claim 9, wherein the transaction network selection device is adapted to read tender information from a check written by a customer participating in the transaction.

20. A method of processing a transaction comprising:
providing a transaction terminal, and a transaction network selection device that is in communication with the transaction terminal and also in communication with a plurality of financial data networks;
selecting, with the transaction network selection device, one of the financial data networks to conduct the transaction based on tender information supplied to the device.

21. The method of claim 20, further comprising receiving the tender information from a transaction card used by a customer for the transaction.

22. The method of claim 20, further comprising settling the transaction on the selected financial data network before starting another transaction.

23. The method of claim 20, further comprising:
starting multiple transactions at the transaction terminal; and
storing data on each of the multiple transactions in memory provided by the transaction network selection device, wherein the multiple transactions are parsed into groups based on the financial network selected to conduct the transaction.

24. The method of claim 23, wherein the method comprises:
settling the group of transactions on the selected financial network in a batch process.
